(19) United States
(12) Patent Application Publication
(10) Pub. No.: US 2016/0281419 A1
(43) Pub. Date: Sep. 29, 2016

(54) CELL AND CLASSROOM DOOR WINDOW COVER AND METHODS FOR USING THE SAME

(71) Applicant: Danieray Johnsen, Rio Rancho, NM (US)

(72) Inventor: Danieray Johnsen, Rio Rancho, NM (US)

(21) Appl. No.: 15/179,820

(22) Filed: Jun. 10, 2016

Related U.S. Application Data
(63) Continuation-in-part of application No. 13/365,214, filed on Feb. 2, 2012, now abandoned.
Application No. 13/365,214 is a continuation-in-part of application No. 13/324,763, filed on Dec. 13, 2011, now abandoned.
Application No. 13/324,763 is a continuation-in-part of application No. 13/272,126, filed on Oct. 12, 2011, now abandoned.

(51) Int. Cl. E06B 7/30; E06B 5/10; E06B 9/24

(52) U.S. Cl. CPC E06B 7/30; E06B 9/24; E06B 5/10

(57) ABSTRACT

Apparatus and methods are disclosed for controlling inmates disposed in their cells during emergency situations. The apparatus and methods may be applied to other doors or windows to block visualization there through. For example, if a school is on lockdown, a teacher may place a window shield on the window in the door to the classroom. This may prevent a threat from seeing into a room and possibly deter the threat from even entering the classroom. The apparatus includes a flexible magnetic cover which can be used by staff as a temporary cover for prison cell or school door windows. The apparatus may include a one-way viewing portion permitting persons to look in only one direction through the window shield. The apparatus could be used in any situation where people are confined for safety and security.

### CROSS-REFERENCE TO RELATED APPLICATIONS

This application is a continuation in part of U.S. patent application Ser. No. 13/365,214, filed Feb. 2, 2012, currently pending, which is a continuation in part of U.S. patent application Ser. No. 13/324,763, filed Dec. 13, 2011, which is a continuation in part of U.S. patent application Ser. No. 13/272,126, filed Oct. 12, 2011, the contents of each of which are herein incorporated by reference.

### BACKGROUND OF THE INVENTION

The present invention relates to emergency preparedness for prisons, schools, hospitals, and the like. The present invention may be used as an inmate control apparatus and methods and, more particularly, to a device that may be used in prisons to cover inmate cell door windows during emergency situations. In schools and colleges, the present invention may be used as an emergency preparedness device to cover classroom door windows, and more particularly, to be used by facility staff during lockdown or other emergency procedures involving safety, security, and emergency preparedness in places of learning, for example.

In North America alone, the U.S. Bureau of Justice Statistics reports in 2009 that there are over 2,292,133 inmates incarcerated in U.S. prisons and jails. Emergency situations can occur inside inmate general and special housing units without notice. In the United States there are over 98,817 public schools teaching over 98,000,000 students. Emergency preparedness, training and proper tools are critical to restoring normal operations, protecting human life and property at prisons, schools, hospitals and other areas.

Twenty-first century correctional facilities design 3^{rd} and 4^{th} generation facilities with steel doors having reinforced glass built into the door without a traditional metal cover. This design prevents escape, allows for natural and artificial lighting, as well as provides for direct and indirect inmate supervision by staff. Yet, experienced correctional professional realized the limitations of a window in the cell door during emergency situations. As a result of increases in criminal, gang, and other criminal deviant behavior, schools throughout the world are developing emergency preparedness plans and procedures for hardening and or fortifying their classrooms. These plans are being developed to decrease and/or reduce the likelihood for dangerous activities within the classroom.

Compliant inmates return to their cells and watch staff through the door windows as they perform their emergency activities. Many times, staff emergency response can prompt violent and angry outburst displays from other inmates locked inside their cells. Facilities may incur property damage, additional injury, or additional unplanned use of force incidents, which may have otherwise not been necessary if the inmates were not able to witness emergency activities occurring outside their cell. When a dangerous intruder enters the school property procedures include hardening the classroom to include covering the classroom door window. Teachers currently are required to cover the window with cardboard, paper and tape. This procedure is cumbersome, and time consuming, thus wasting valuable time.

As can be seen, there is a need for apparatus and methods for limiting the ability of inmates or school intruders to view activities outside of their cell through their cell door window during emergency situations, or into classroom settings.

### SUMMARY OF THE INVENTION

In one aspect of the present invention, a method for temporarily limiting visibility through a window comprises removably affixing a flexible magnetic material onto a metal periphery of the window, wherein the flexible magnetic material blocks visibility through the window.

In another aspect of the present invention, a method for limiting an inmate's/intruders visibility through a detention room door window or classroom door, during an incident comprises removably affixing a flexible magnetic material onto a metal periphery of the window, wherein the flexible magnetic material blocks visibility through the window; and removing the flexible magnetic material once the incident is over.

In a further aspect of the present invention, a method for assisting in the control of inmates during an emergency situation comprises directing inmates into their cells during the emergency situation; and blocking view outside of the cell by removably affixing a flexible magnetic material onto a metal periphery of the window. In a further aspect of the present invention a method of blocking school intruders view into class room windows or the like.

These and other features, aspects and advantages of the present invention will become better understood with reference to the following drawings, description and claims.

### BRIEF DESCRIPTION OF THE DRAWINGS

FIG. 1A is a front view of an exemplary embodiment of a prison cell door or class room door;

FIG. 1B is a front view of another exemplary embodiment of a prison cell or class room door;

FIG. 1C is a front view of yet another exemplary embodiment of a prison cell or cell door;

FIG. 2 is a front view of a temporary cell or school door window blocking device according to an exemplary embodiment of the present invention; and

FIG. 3 is a front view of a temporary cell or school door window blocking device according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides apparatus and methods for controlling inmates disposed in their cells, and blocking visibility into class room doors during emergency situations. The apparatus of the present invention includes a flexible magnetic cover which can be used by staff as a temporary cover for prison cell and class room door windows. The apparatus may be used to help limit the inmate's visualization of prison emergency responses. Modern prison cell door and school classroom designs include a cell/classroom door window but do not include any means to block this window. The apparatus may include a one-way viewing portion permitting persons outside the cell to look into the cell, but not permitting inmates inside the cell to see outside. The apparatus can be used in other situations, such as on operating room doors, for emergency room door windows, mental hospitals, schools, universities and in other situations where temporary blocking of a window is desirable. The apparatus could be used in any situation where people are confined for safety and security.

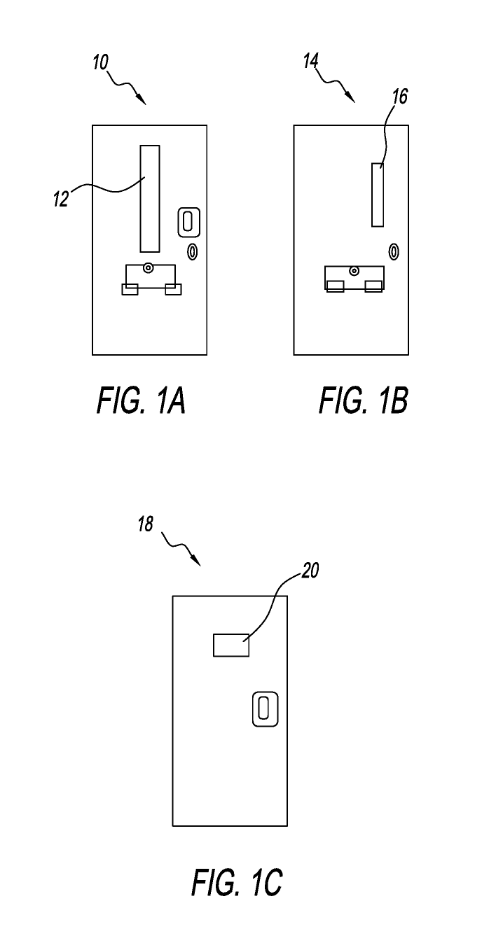

Referring to FIG. 1A, a prison cell/classroom door 10 may include a long vertical central window 12. Alternatively, as shown in FIG. 1B, a prison cell/classroom door 14 (or some other door having a window) may include a vertical offset window 16. Furthermore, as shown in FIG. 1C, a prison cell/classroom door 18 may include a horizontal window 20. In either case, the window 12, 16, 20 may not include a means to block view through the window. Prior door designs include a hinged metal barrier that may be closed over the window. However, modern prison/school door design does not include such a metal door.

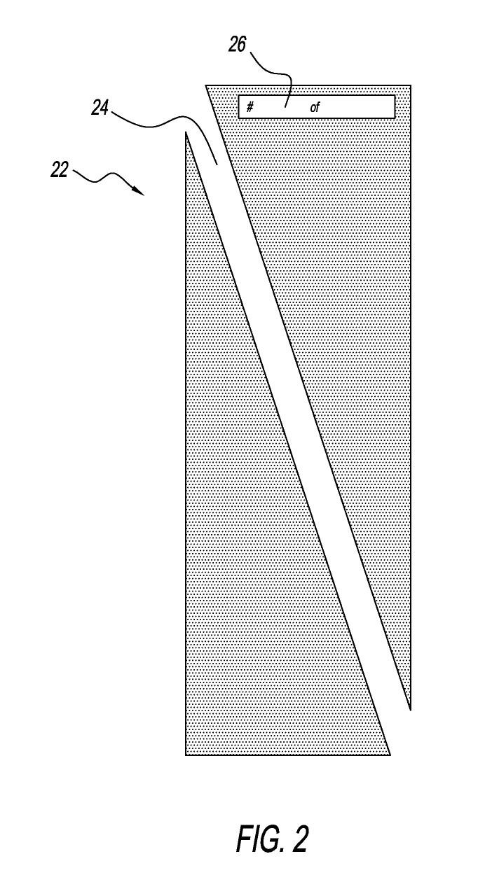

Referring to FIG. 2, a temporary window shield 22 may be a flexible magnet adapted to magnetically attach to at least a portion of an area framing the window 12, 16, 20. When the window shield 22 is in place, a person may not be able to see through the window. Such a window shield 22 may be especially useful where temporary blockage of a window in a metal door is beneficial. For example, the window shield 22 may be useful in a prison situation, where inmates inside cells may be blocked from visualizing activities outside of the cell. This may be especially useful in emergency situations, where an inmate witnessing an emergency response may respond violently. The window shield 22 may be used in other situations, such as on operating room doors, for emergency room door windows, in schools and universities, and in other situations where temporary blocking of a window is desirable. The window shield 22 can also be used in mental hospitals, where a similar door design may be used. The window shield 22 could be used in any situation where people are confined for safety and security.

The window shield 22 may be of various thicknesses, such as 10 mil, 20 mil, 30 mil, 40 mil, or other thickness. The window shield 22 may be, for example, made of vinyl or rubber flexible magnetic material. In some embodiments, the window shield 22 may be formed or one or more materials. In some embodiments, the window shield 22 may be formed from 100 percent isotropic magnetic material. In some embodiments, the window shield 22 may be formed from a non-flammable material. In some embodiments, the window shield 22 may contain no glues or other such components that may generate harmful fumes during heating or combustion.

Traditional vinyl materials are made from three components—magnetic rubber, glue and plastic vinyl. During a fire, glue and the colored vinyl become toxic to human inhalation. The isotropic rubber window shield 22 of the present invention overcomes these issues by being made from 100 percent isotropic material which, during a fire, will not ignite or produce harmful toxins. The window shield 22 can be manufactured without any glue or vinyl.

The window shield 22 may have a warning stripe 24 diagonally thereacross. The window shield 22 may be colored a dark, neutral color, whereas the warning stripe 24 may be colored a bright, contrasting color. For example, the window shield 22 may be black and the warning stripe 24 may be yellow.

The window shield 22 may include an inventory control item 26, such as a space having a first black and a second blank separated by the word “of”. In this manner, the window shields 22 may be consecutively numbered 1 of 100, 2 of 100, 3 of 100, and the like. This system may help track inventory of the window shields 22 in an institutional setting, for example.

The window shield 22 may be made by a variety of methods and of a variety of materials. In some embodiments, the color on the front of the window shield and the warming stripe 24 may be embossed on the flexible magnetic material. In other embodiments, the color and the warning stripe 24 may be a separate piece attached to the flexible magnetic material.

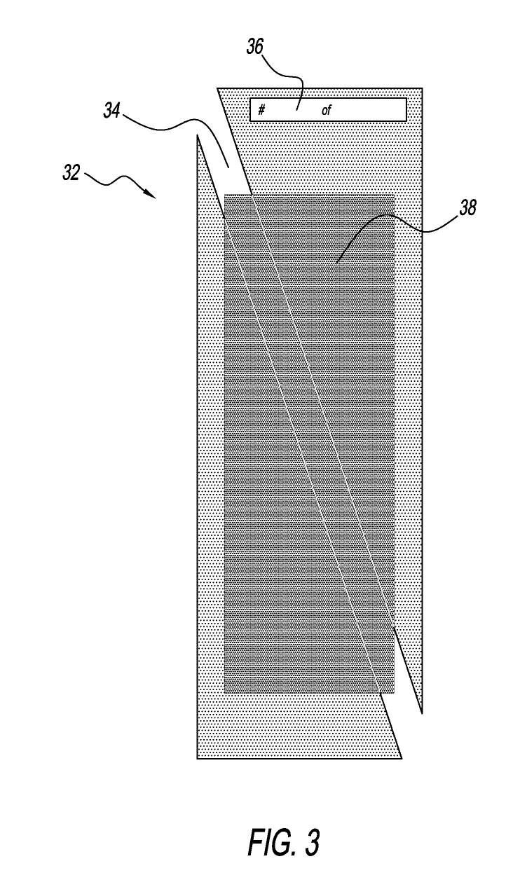

Referring now to FIG. 3, a window shield 32 may be designed similar to the window shield 22, as described above, except a portion of the window shield 32 may be formed of a one-way viewing material 38. As shown in FIG. 3, the one-way viewing material 38 may be disposed as a concentric rectangle in a central region of the window shield 32. In other embodiments, the one-way viewing material 38 may be disposed in one or more locations in the window shield 32 and may be shaped as a square, circle, rectangle, or other geometric or non-geometric shape. The one-way viewing material 38 may permit a user to see through the window shield 32 in one direction, but not in the other direction. The one-way viewing material 38 may be vinyl, fabric, or any other material capable of achieving the one-way viewing property.

The window shield 32 may include a warning stripe 34, which may be of similar size, shape, color and function as described above. The warning stripe 34 may be colored across the one-way viewing material 38. In some embodiments, the warning stripe 34 may be colored across the one-way viewing material 38 and may be configured to provide one way viewing through the portion of the warning stripe 34 that passes over the one-way viewing material 38. The window shield 32 may further include an inventory control item 36, which may be of similar size, shape, color and function as described above.

The one-way viewing material 38 may be disposed to cover a hole in the window shield 32. The one-way viewing material 38 may be attached to the window shield 32 in a variety of manners. For example, if the one-way viewing material 38 includes more than one layer, the one-way viewing material 38 may be sandwiched between the layers. In other embodiments, the one-way viewing material 38 may be adhered to the window shield 32 by a flexible adhesive. Typically, the one-way viewing material 38 may be flexible, similar to the window shield 32 itself.

The window shield 22, 32 may be used during emergency preparedness at schools or applied to prison cell door windows to help control inmates during emergency situations. The window shield 22, 32 may be used in methods to limit visualization through a window. The window shield 22, 32 may, in a prison or schools situation, for example, help reduce the possibility of retaliation from inmates and staff when they witness emergency responses. The window shield 22, 32 may help protect emergency responders, reduce property damage by spectator inmates, ensure staff and inmate privacy during emergencies, eliminate violent psychological inmate trauma, ensure privacy during high profile movements, reduce costly inmate litigation, and the like. When an emergency situation is complete, staff may simple remove the window shield 22, 32 from the windows, stack them together, and store them for future use.

The window shield 22, 32 may be applied to other doors or windows to block visualization therethrough. For example, if a school is on lockdown, a teacher may place a window shield 22, 32 on the window in the door to the classroom. This may prevent a threat from seeing into a room and possibly deter the threat from even entering the classroom.

It should be understood, of course, that the foregoing relates to exemplary embodiments of the invention and that modifications may be made without departing from the spirit and scope of the invention as set forth in the following claims.

What is claimed is:

1. A method for temporarily limiting visibility through a window, the method comprising:
removably affixing a flexible magnetic material onto a metal periphery of the window, wherein the flexible magnetic material blocks visibility through the window, wherein the flexible magnetic material is formed completely from isotropic magnetic material.

2. The method of claim 1, wherein the window is a window in a door.

3. The method of claim 1, wherein the window is a window in a prison cell door.

4. The method of claim 1, wherein the window is a window in a door of a school classroom.

5. The method of claim 1, further comprising assigning an inventory control number with each of the flexible magnetic material disposed on each of the windows.

6. The method of claim 1, wherein a warning stripe is visibly viewable from one side of the window.

7. The method of claim 1, wherein a one-way viewing material covers at least one hole in the flexible magnetic material.

8. A method for limiting an inmate's visibility through a detention room door window during an incident, the method consisting of:
removably affixing a flexible magnetic material onto a metal periphery of the window, wherein the flexible magnetic material blocks visibility through the window; and
removing the flexible magnetic material once the incident is over.

9. The method of claim 8, further comprising assigning an inventory control number with each of the flexible magnetic material disposed on each of the windows.

10. The method of claim 8, wherein a warning stripe is visibly viewable from one side of the window.

11. The method of claim 8, wherein a one-way viewing material covers at least one hole in the flexible magnetic material.

12. The method of claim 8, wherein the flexible magnetic material is formed completely from isotropic magnetic material.

13. A method for increasing emergency preparedness of an organization, the method consisting of:
providing a flexible magnetic material to persons in the organization, the flexible magnetic material adapted to block visibility through a window by magnetically attaching to a frame of the window;
wherein the window blocks an area where people are confined for safety and security.

14. The method of claim 13, further comprising applying the flexible magnetic material to cover the window in an emergency situation and removing the flexible magnetic material after the emergency situation is complete.

15. The method of claim 13, further comprising assigning an inventory control number with each of the flexible magnetic material disposed on each of the windows.

16. The method of claim 13, wherein a warning stripe is visibly viewable from one side of the window.

17. The method of claim 13, wherein a one-way viewing material covers at least one hole in the flexible magnetic material.

18. The method of claim 13, wherein the organization is a school.

19. The method of claim 13, wherein the organization is a prison.

20. The method of claim 13, wherein the flexible magnetic material is completely formed from an isotropic magnetic material.
